(19) United States
(12) Patent Application Publication
(10) Pub. No.: US 2022/0402165 A1
(43) Pub. Date: Dec. 22, 2022

(54) MOBILE OPERATING MACHINE AND FUNCTIONING METHOD OF SAID MOBILE OPERATING MACHINE

(71) Applicant: CIFA SPA, Senago (IT)

(72) Inventors: Massimo CALCULLI, Novate Milanese (IT); Paolo Dario MAINI, Lissone (IT)

(21) Appl. No.: 17/844,987

(22) Filed: Jun. 21, 2022

(30) Foreign Application Priority Data
Jun. 18, 2021 (IT) 102021000015947

(51) Int. Cl. B28C 5/42

(52) U.S. Cl. CPC B28C 5/4213; B28C 5/4258

(57) ABSTRACT

A mobile operating machine comprising a motor vehicle moved by an endothermic engine, an articulated arm, a pumping unit and a stabilizing unit wherein the endothermic engine is provided with at least two power take-offs. The mobile operating machine also comprises a hydraulic pump and an electric motor operatively connected to the endothermic engine, to the hydraulic pump and to an electric accumulator.

### FIELD OF THE INVENTION

The present invention concerns a mobile operating machine and its functioning method.

In particular, the mobile operating machine to which the present invention refers is preferably a truck-mounted pump for the delivery and distribution of concrete.

### BACKGROUND OF THE INVENTION

In the field of civil construction, the use is known of mobile operating machines, such as truck-mounted pumps, or suchlike, that is, pumps with a corresponding arm to deliver concrete that are mounted on a transport vehicle.

Truck-mounted pumps normally comprise an articulated arm that can be extended to several segments, a pumping unit which has the function of pumping the concrete toward the delivery zone, and a stabilizing unit, provided with one or more extendable support feet, which has the function of stabilizing the entire vehicle during the pumping and delivery of the concrete.

The articulated arm is associated with a pipe that extends for its entire length, and through this pipe the concrete is pumped to be delivered to the desired zone by the operator.

The last portion of the pipe is the one that is handled by the operator to perform the delivery and targeted distribution of the concrete.

Each segment, or section, of the articulated arm is associated with at least its own actuator, or hydraulic motor, which allows the rotation and movement of one section with respect to the other.

In the current state of the art, the drive of the concrete pumping unit, and possibly of the actuators associated with the arm, is commanded by an endothermic engine, for example a diesel engine, which is the same one that drives the vehicle engine of the mobile operating machine.

Therefore, one disadvantage of known mobile operating machines is that, for the entire duration of the distribution of the concrete, the endothermic engine must remain switched on, causing prolonged emissions of exhaust gases that are harmful to both health and the environment.

Furthermore, known mobile operating machines are often noisy, and therefore also have problems of noise pollution.

Solutions of operating machines are known, for example concrete mixers, which use hybrid-type engine solutions, in which, for example, the drive of the concrete mixing drum is entrusted at least partly to an electric motor.

Document DE102018214965A1 generically describes a truck-mounted hybrid pump where a liquid-cooled asynchronous motor is installed, that is, an electric motor characterized by specific functions, which can be connected to an endothermic engine and/or to an electric accumulator. The connection between the endothermic engine and the electric motor takes place by means of a transmission shaft. The electric motor and the accumulator can be connected to an external electric network for recharging and power. In this document, however, the electric functioning of the truck-mounted pump is not described in detail.

Document U.S. Pat. No. 9,850,671B2 describes an electric operating machine used specifically for working in tunnels, having a generator to power the various functions of the operating machine, in particular for the front and/or rear traction of the same machine. The generator can be powered either by an external electric network or by an endothermic engine. Specifically, the endothermic engine is mainly used for moving the operating machine.

There is therefore a need to perfect, or produce, a mobile operating machine, in particular a truck-mounted pump equipped with an articulated arm for the delivery and distribution of concrete, which can overcome at least one of the disadvantages of the state of the art.

One purpose of the present invention is to provide a mobile operating machine, in particular a truck-mounted pump, which is efficient and versatile for the different modes of use for which the machine is intended, and in particular reduces polluting emissions and noise emissions when it is functioning.

A derived purpose is therefore to be able to use the operating machine even in city centers, or in particular sensitive areas and in any time band, without problems of noise and environmental pollution.

Another purpose of the present invention is to provide a mobile operating machine in which the drive of at least some of the operating components of the operating machine takes place without the aid of the endothermic engine.

In particular, one purpose of the present invention is to provide a mobile operating machine in which the articulated arm, or the stabilizing system, can be driven even when the endothermic engine is switched off, for example when the vehicle is stationary.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a mobile operating machine according to the present invention comprises a motor vehicle moved by an endothermic engine, an articulated arm associated with a concrete delivery pipe, a pumping unit suitable to pump concrete into the pipe and a stabilizing unit for stabilizing the operating machine at least during the pumping and delivery of the concrete.

In accordance with one aspect of the present invention, the endothermic engine is provided with at least a first power take-off and a second power take-off distinct from the first power take-off, which can be selectively activated with respect to each other.

In accordance with another aspect of the present invention, at least one hydraulic pump which drives the articulated arm and the stabilizing unit, and an electric motor and accumulator are connected to the first power take-off, by means of a first drive axis, and at least the pumping unit is connected to the second power take-off by means of a second drive axis, distinct from the first drive axis.

In accordance with another aspect of the present invention, along the first power take-off there is a disengagement device which can be selectively activated to alternatively determine the drive of the hydraulic pump by means of the endothermic engine or by means of the electric motor.

Thanks to the configurations indicated above, the truck-mounted pump according to the present invention can be used, for the operating part relating to the movement of the stabilizers and the articulated arm, exclusively by driving the electric motor, therefore in a silent and non-polluting way, while only the part relating to the pumping of concrete is entrusted to the drive of the endothermic engine.

In this way, polluting and noise emissions are substantially reduced compared to known solutions.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic view of a mobile operating machine according to the present invention;

FIG. 2 is a schematic view of a first functioning mode of the mobile operating machine of FIG. 1;

FIG. 3 is a schematic view of a second functioning mode of the mobile operating machine of FIG. 1;

FIG. 4 is a schematic view of a third functioning mode of the mobile operating machine of FIG. 1;

FIG. 5 is a schematic view of a fourth functioning mode of the mobile operating machine of FIG. 1.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

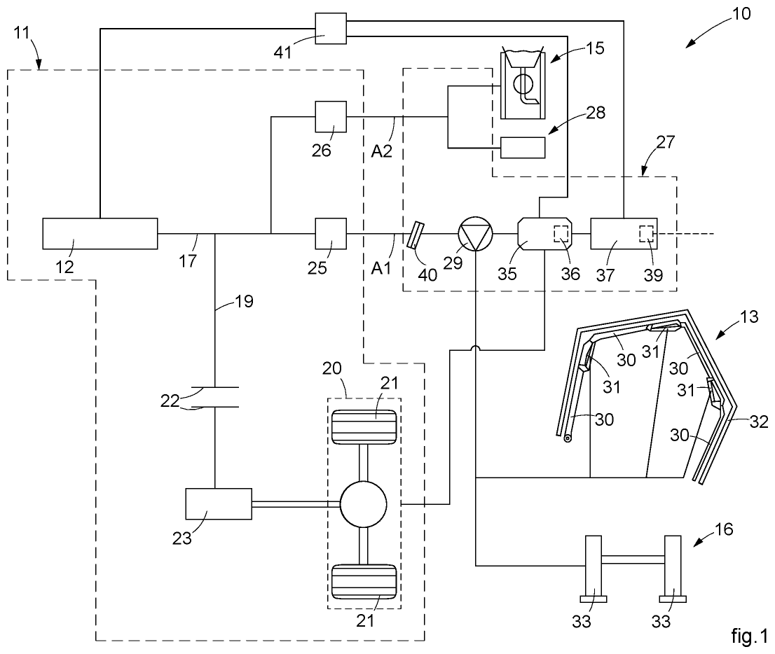

With reference to FIG. 1, a mobile operating machine, which in this case is a truck-mounted pump 10, is used for the distribution and delivery of concrete in operating sites, for example a construction site.

The mobile operating machine 10 schematically comprises a conventional motor vehicle 11, represented in its entirety by a broken line, moved by an endothermic engine 12, such as a conventional diesel engine.

Mounted on the motor vehicle 11 there is an articulated arm 13 associated with an extendable pipe 32 for delivering concrete, a pumping unit 15, and a stabilizing unit 16 which has the function of stabilizing the motor vehicle 11 once it has reached the operating site.

The endothermic engine 12 is provided with a drive shaft 17 which allows to rotate a transmission shaft 19 of a movement unit 20, which is provided with wheels 21. A clutch 22 and a gearbox 23 of any known type can be associated with the drive shaft 17, to determine the drive of the movement unit 20.

Furthermore, the endothermic engine 12 is connected to at least a first power take-off 25 and a second power take-off 26 which are distinct from each other and can be activated selectively with respect to each other.

The mobile operating machine 10 also comprises a drive apparatus 27, indicated in its entirety by a broken line, operatively connected to the power take-offs 25, 26 of the endothermic engine 12 and configured to drive the articulated arm 13, the pumping unit 15, the stabilizing unit 16, as well as other electric or hydraulic service units 28 of the operating machine 10.

In particular, the drive apparatus 27 has a first drive axis, indicated by A1, associated with the first power take-off 25 and a second drive axis, indicated by A2, associated with the second power take-off 26.

A hydraulic pump 29 is positioned along the first drive axis A1, operatively connected to the first power take-off 25 and configured to pump a work fluid to determine the selectively alternating drive of the articulated arm 13 and the stabilizing unit 16.

In particular, the articulated arm 13 comprises a plurality of sections 30 reciprocally articulated and moved by respective hydraulic actuators 31, or motors, and the pipe 32, associated with the sections 30, through which the concrete is pumped toward the delivery zone. The actuators 31 are operatively connected to the hydraulic pump 29 which drives them by supplying them with the work fluid so that the articulated arm 13 can assume the desired position.

The stabilizing unit 16 comprises one or more support devices 33, for example extendable support feet, preferably distributed symmetrically on the perimeter of the operating machine 10. The support devices 33 are also operatively connected to the hydraulic pump 29 which drives them, supplying them with the work fluid so that they can be moved to stabilize and secure the operating machine 10 before and during pumping and delivery of the concrete.

The drive apparatus 27 also comprises, disposed along the first drive axis A1 and operatively connected to each other, an electric motor 35, provided with a converter 36 which acts as an inverter, and connected in turn to the hydraulic pump 29, and an electric accumulator 37.

In accordance with one aspect of the present invention, the hydraulic pump 29 is the type which also allows the connection, and therefore the transmission of mechanical energy, from the endothermic engine 12 to the electric motor 35.

In particular, the electric motor 35 can assume at least a first operating condition in which it converts the electrical energy of the electric accumulator 37 into mechanical energy to drive the hydraulic pump 29, and a second operating condition in which it converts the mechanical energy of the endothermic engine 12 into electrical energy to recharge the electric accumulator 37. Therefore, the electric motor 35 can function both as a motor and as a generator.

The converter 36 is responsible for the control of the electric motor 35, that is, the management of continuous and/or alternating electrical energy, and is operatively connected to the electric accumulator 37.

The electric accumulator 37 comprises, for example, one or more electric batteries and can be provided with a connection device 39 configured to connect the electric accumulator 37 to an electrical energy source, for example a normal electric network, when the energy level of the electric accumulator 37 is low.

In accordance with another aspect of the present invention, along the first drive axis A1, between the first power take-off 25 and the hydraulic pump 29, a disengagement device 40 is positioned, for example an overrun joint or free wheel, configured to selectively disconnect the first power take-off 25 of the endothermic engine 12 from the hydraulic pump 29 and from the electric motor 35.

In particular, the disengagement device 40, when it is connected, allows the transmission of the mechanical energy of the endothermic engine 12 to the hydraulic pump 29 and, possibly, to the electric motor 35, which in this case acts as a generator to recharge the accumulator 37, for example in the case of a KERS-type energy recovery system; on the contrary, when it is disconnected, it prevents the transmission of the mechanical energy generated by the electric motor 35 toward the endothermic engine 12.

In this way, the articulated arm 13 and the stabilizing unit 16 can function in hybrid mode, that is, alternatively, either by means of the endothermic engine 12 or by means of the electric motor 35.

In particular, the preferential drive will take place through the electric motor 35 and, at least in the event that the energy level in the accumulator 37 falls below a certain threshold, the drive will be switched by means of the endothermic engine 12.

Along the second drive axis A2 of the drive apparatus 27, operatively connected to the second power take-off 26, there is the pumping unit 15, that is, the unit suitable to pump concrete through the pipe 32 associated with the articulated arm 13, and other electric or hydraulic service units 28.

The mobile operating machine 10 also comprises a central control unit 41 which is operatively connected at least to the endothermic engine 12, to the electric motor 35 and to the electric accumulator 37.

The central control unit 41 is programmed to automatically manage both the hybrid mode of the articulated arm 13 and the stabilizing unit 16, and also the start and stop of the endothermic engine 12, when the pumping unit 15 is activated and, respectively, deactivated, possibly to activate, for example, the stabilizing unit 16.

In particular, in the management of the hybrid mode, the central control unit 41 is set so as to preferentially start the electric motor 35 to drive the hydraulic pump 29, the stabilizing unit 16 to secure the operating machine 10 and therefore the articulated arm 13. In this situation, as we said, the endothermic engine 12 can be started automatically in order to drive the articulated arm 13 or the stabilizing unit 16 only when the level of energy accumulated in the electric accumulator 37 is, or falls below a minimum energy threshold.

Of course, in the case of special needs, it is also possible to provide automatic management of the hybrid mode by the central control unit 41, by setting a working mode other than the automatic one.

The functioning of the mobile operating machine 10 described heretofore, which corresponds to the method according to the present invention, comprises at least four functioning modes F1, F2, F3, F4.

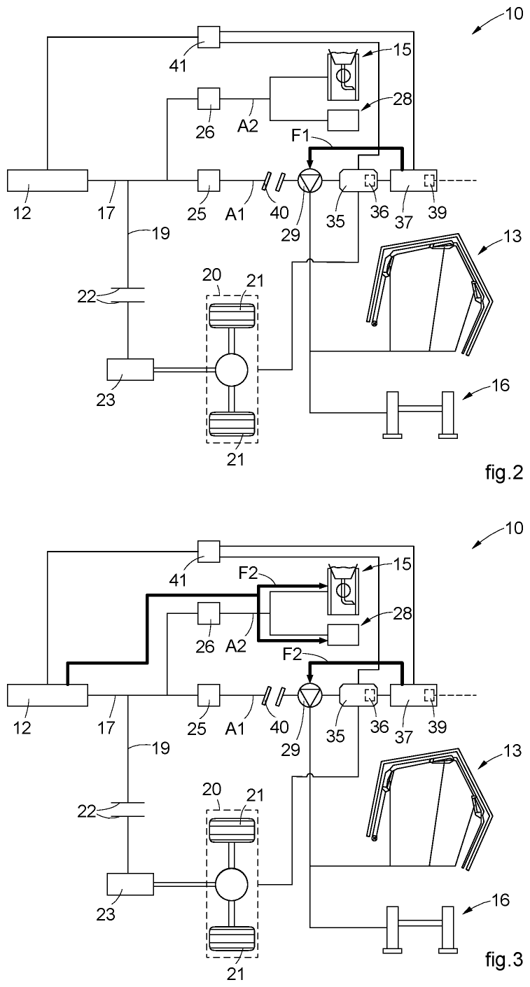

A first functioning mode F1 of the mobile operating machine 10 according to the present invention is shown in FIG. 2 and comprises the following steps:

the mobile operating machine 10 is moved by the endothermic engine 12, which drives the movement unit 20 to reach the desired position on a construction site;

the mobile operating machine 10 is stationary and the disengagement device 40 is deactivated, therefore the electric motor 35 is disconnected from the first power take-off 25;

the electric motor 35, in this case, assumes the first operating condition, that is, it takes electrical energy from the electric accumulator 37 using the converter 36, and then transforms it into mechanical drive energy to drive the hydraulic pump 29;

the hydraulic pump 29 pumps the work fluid, driving the stabilizing unit 16, and causes the movement of one or more support devices 33 so as to stabilize the operating machine 10;

then, the hydraulic pump 29 pumps the work fluid, driving the articulated arm 13 to position it in the desired position.

A second functioning mode F2 of the mobile operating machine 10 according to the present invention is shown in FIG. 3 and comprises, in addition to the steps of the first functioning mode F1, the following step:
the endothermic engine 12 is started and by means of the second power take-off 26 drives the pumping unit 15, which pumps the concrete through the pipe 32 of the articulated arm 13 for final delivery. Possibly, in this step it is also possible to drive the other electric or hydraulic service units 28.

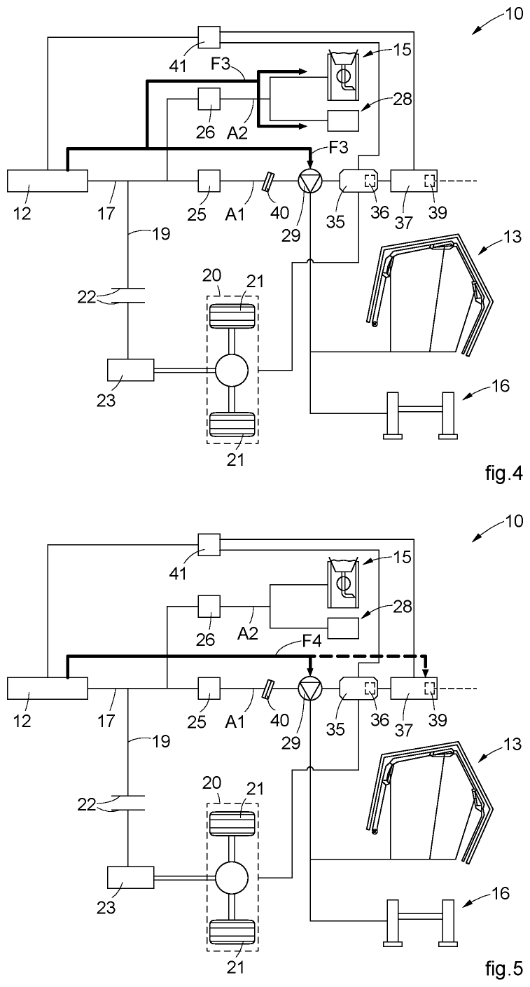

A third functioning mode F3 of the mobile operating machine 10 according to the present invention is shown in FIG. 4 and comprises the following steps:

the mobile operating machine 10 is moved by the endothermic engine 12, which drives the movement unit 20 to reach the desired position on a construction site;

the mobile operating machine 10 is stationary and the disengagement device 40 is activated;

the endothermic engine 12 is driven and by means of the first power take-off 25 transmits mechanical energy to the hydraulic pump 29 in order to drive it;

the hydraulic pump 29 pumps the work fluid, activating the stabilizing unit 16, and causes the lowering of one or more support devices 33 in order to stabilize the operating machine 10 for the subsequent pumping and subsequent delivery of the concrete;

the hydraulic pump 29 pumps the work fluid, driving the articulated arm 13 to position it in the desired position;

by means of the second power take-off 26, the endothermic engine 12 drives the pumping unit 15, which pumps the concrete through the pipe 32 of the articulated arm 13 for final delivery. Possibly, in this step it is also possible to drive the other electric or hydraulic service units 28.

A fourth functioning mode F4 of the mobile operating machine 10 according to the present invention is shown schematically in FIG. 5 and comprises the following steps:

the mobile operating machine 10 is stationary and the disengagement device 40 is activated;

the endothermic engine 12 is driven and by means of the first power take-off 25 transmits mechanical energy to the electric motor 35 which, in this case, assumes the second operating condition, in which by means of the electronic converter 36 it transfers electrical energy to the electric accumulator 37 in order to recharge it.

Furthermore, the electric accumulator 37 can be connected, by means of the connection device 39, to a source of electrical energy, for example to the electricity network, to be recharged.

The use of the electric motor 35, compared to the endothermic engine 12, has the following advantages:

the electric motor 35 has a higher working efficiency compared to the efficiency of the endothermic engine 12;

emissions of fumes harmful to both the environment and health are significantly reduced;

noise pollution is significantly reduced.

Furthermore, the positioning of the disengagement device 40 along the first drive axis A1 has the advantage of allowing the management of the torque entering and/or leaving the first drive axis A1 without generating imbalances in the endothermic engine 12 of the motor vehicle 11, that is, without altering the behavior of the endothermic engine 12.

It is clear that modifications and/or additions of parts or steps may be made to the mobile operating machine 10 and the functioning method as described heretofore, without departing from the field of the present invention as defined by the claims.

It is also clear that, although the present invention has been described with reference to a specific example, a person of skill in the art shall certainly be able to achieve many other equivalent forms of the mobile operating machine and the functioning method, having the characteristics as set forth in the claims and hence all coming within the field of protection defined thereby.

1. A mobile operating machine comprising a motor vehicle moved by an endothermic engine, an articulated arm associated with a concrete delivery pipe, a pumping unit suitable to pump concrete into said pipe and a stabilizing unit for stabilizing said operating machine during the pumping and delivery of said concrete, wherein said endothermic engine is provided with at least a first power take-off and a second power take-off, distinct from the first power take-off, which can be activated selectively with respect to each other, wherein at least one hydraulic pump which drives said articulated arm and said stabilizing unit, an electric motor and an electric accumulator are connected to said first power take-off by means of a first drive axis (A1), and at least said pumping unit is connected to said second power take-off by means of a second drive axis (A2), distinct from said first drive axis (A1), and wherein along said first power take-off there is a disengagement device which can be selectively activated to alternatively determine the drive of said hydraulic pump by means of said endothermic engine, or by means of said electric motor.

2. The mobile operating machine as in claim 1, wherein said electric motor is configured to assume at least a first operating condition, in which it converts the electrical energy of said electric accumulator into mechanical energy that drives said hydraulic pump, and a second operating condition, in which it converts the mechanical energy of said endothermic engine into electrical energy to recharge said electric accumulator.

3. The mobile operating machine as in claim 1, wherein said hydraulic pump is of the type that allows the transmission of mechanical energy from said endothermic engine to said electric motor.

4. The mobile operating machine as in claim 1, further comprising a converter operatively connected to said electric motor and to said electric accumulator and configured to manage the direct and/or alternating electrical energy of said electric motor.

5. The mobile operating machine as in claim 1, wherein said electric accumulator is provided with a connection device for the connection to a source of electrical energy.

6. The mobile operating machine as in claim 1, further comprising a central control unit operatively connected at least to said endothermic engine, to said electric motor and to said electric accumulator, and configured to automatically manage the drive of said hydraulic pump by means of said electric motor, or by means of said endothermic engine.

7. The mobile operating machine as in claim 6, wherein said central control unit is configured to also automatically manage the start and stop of said endothermic engine, when said pumping unit is activated and, respectively, deactivated.

8. A functioning method of a mobile operating machine as in claim 1, in which at least a first functioning step it is provides in which said stabilizing unit and said articulated arm are driven by a hydraulic pump powered by an electric motor associated with electrical energy storage means of the accumulator type, and a second functioning step in which said pumping unit is driven by means of said endothermic engine.

9. The functioning method as in claim 8, comprising at least one functioning step in which said stabilizing unit and said articulated arm are driven by the hydraulic pump, which is driven by said endothermic engine in the event that the energy level in said electric accumulator is below a determinate threshold.

10. The functioning method as in claim 8, comprising at least one step of recharging said electric accumulator from a source of electrical energy and/or by means of said endothermic engine passing through said hydraulic pump and said electric motor.
